(19) United States
(12) Patent Application Publication
(10) Pub. No.: US 2024/0208507 A1
(43) Pub. Date: Jun. 27, 2024

(54) AUTOMATIC VEHICLE FEATURE SELECTION

(71) Applicant: GM GLOBAL TECHNOLOGY OPERATIONS LLC, Detroit, MI (US)

(72) Inventors: Matthew G. Przybylski, Fenton, MI (US); Craig H. Zinser, Clarkston, MI (US); James Scott Creehan, Dexter, MI (US)

(73) Assignee: GM GLOBAL TECHNOLOGY OPERATIONS LLC, Detroit, MI (US)

(21) Appl. No.: 18/086,972

(22) Filed: Dec. 22, 2022

(51) Int. Cl. B60W 30/182; B60Q 5/00; B60W 20/00

(52) U.S. Cl. CPC B60W 30/182; B60Q 5/008; B60W 20/00; B60W 2555/00; B60W 2556/00

(57) ABSTRACT

A method of automatic selection of an operating mode of a motor vehicle feature includes receiving, via an electronic controller, an input signal communicated by an input device, including at least one of a geographical and a temporal condition for operation of the motor vehicle feature. The method also includes setting, via the electronic controller, at least one of the geographical and the temporal condition for operation of the motor vehicle feature. The method additionally includes determining, via the electronic controller, a current geographical location of the motor vehicle and/or a current time. The method also includes comparing, via the electronic controller, the current geographical location and/or the current time with the corresponding set condition. Furthermore, the method includes selecting, via the electronic controller, the operating mode of the motor vehicle feature when the current geographical location and/or the current time matches the corresponding set condition.

### INTRODUCTION

The present disclosure relates to a system and a method for automatic selection of vehicle modes or features.

To enhance vehicle user experience, modern motor vehicles offer a variety of selectable features and modes designed to provide adjustability of vehicle systems to various needs and wants of the vehicle operator. For example, a vehicle may have selectable driving modes, such as tour, economy, and sport ranges, a selection between which may markedly alter the driving character and performance capability of the vehicle. The tour mode may be specifically tuned to provide relaxed suspension damping to improve vehicle ride comfort and operate the powertrain with reduced harshness and noise. The economy mode may alter vehicle operating parameters to optimize powertrain efficiency. Conversely, the sport mode may tighten the vehicle's suspension damping and sharpen its steering and powertrain response, thus increasing vehicle performance capabilities. The vehicle may also be programmed to set one of such modes as default, which is automatically selected by vehicle electronics each time the vehicle is restarted. Although preference between individual modes may be dependent on the user's mood and other unpredictable circumstances, certain selections may be influenced by external factors and be predictable and/or repetitive.

### SUMMARY

A method of automatic selection of an operating mode of a motor vehicle feature includes receiving, via an electronic controller, an input signal communicated by an input device, including at least one of a geographical and a temporal condition for operation of the motor vehicle feature. The method also includes setting, such as via storing in non-volatile memory of the electronic controller, at least one of the geographical and the temporal condition for operation of the motor vehicle feature. The method additionally includes determining, via the electronic controller, a current geographical location of the motor vehicle and/or a current time. The method also includes comparing, via the electronic controller, the current geographical location and/or the current time with the corresponding set condition. Furthermore, the method includes selecting, via the electronic controller, the operating mode of the motor vehicle feature when the current geographical location and/or the current time matches the corresponding set condition.

The operating mode of the motor vehicle feature may generate an external sound below a predetermined sound level.

The motor vehicle may include an internal combustion engine. In such an embodiment, the motor vehicle feature may be a multiple-mode exhaust system connected to the internal combustion engine.

The multiple-mode exhaust system may include an exhaust-flow control valve. In such an embodiment, selecting the operating mode of the motor vehicle feature may include regulating the exhaust-flow control to switch the multiple-mode exhaust system to a high-restriction mode.

The motor vehicle may include electric propulsion. In such an embodiment, the motor vehicle feature may be an electronically synthesized external sound.

Selecting the operating mode of the motor vehicle feature may include selecting at least one of quality and volume of the electronically synthesized external sound.

The motor vehicle may include a navigation device in communication with each of the electronic controller and a global positioning system (GPS). In such an embodiment, determining the current geographical location of the motor vehicle may include receiving, via the navigation device, a satellite signal from the GPS.

Determining the current geographical location of the motor vehicle may additionally include communicating to the electronic controller, via the navigation device, an electronic signal indicative of the received satellite signal.

The electronic controller may include an internal clock. In such an embodiment, determining the current time may be achieved via the internal clock. The temporal condition may be a 9 PM-9 AM quiet time slot and the geographical condition may be a quiet zone defined by a predetermined radius from a particular geographical location.

Navigation device may include a touch-sensitive (display and command) input screen indicating the geographical position condition and the temporal condition. In such an embodiment, the input of at least one of the geographical and the temporal condition may be received via manual selection of the quiet zone and of the time slot by an operator.

Multiple quiet zones and corresponding quiet time slots may be stored within the non-volatile memory of the electronic controller.

A system for automatic selection of an operating mode of a motor vehicle feature having an input device arranged in a motor vehicle and an electronic controller programmed with an algorithm including the above-described method and configured to execute the algorithm is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a plan view of a motor vehicle powered by an internal combustion engine traversing a geographical area; the vehicle employing a system for vehicle navigation and a multiple-mode exhaust system embodiment of a vehicle feature, according to the present disclosure.

FIG. 2 is a plan view of a motor vehicle powered by an electric motor traversing a geographical area; the vehicle employing a system for vehicle navigation and an electronically synthesized external sound embodiment of a vehicle feature, according to the present disclosure.

FIG. 3 is a flow diagram of a method of automatic selection of an operating mode of a motor vehicle feature shown in FIGS. 1 and 2, according to the present disclosure.

### DETAILED DESCRIPTION

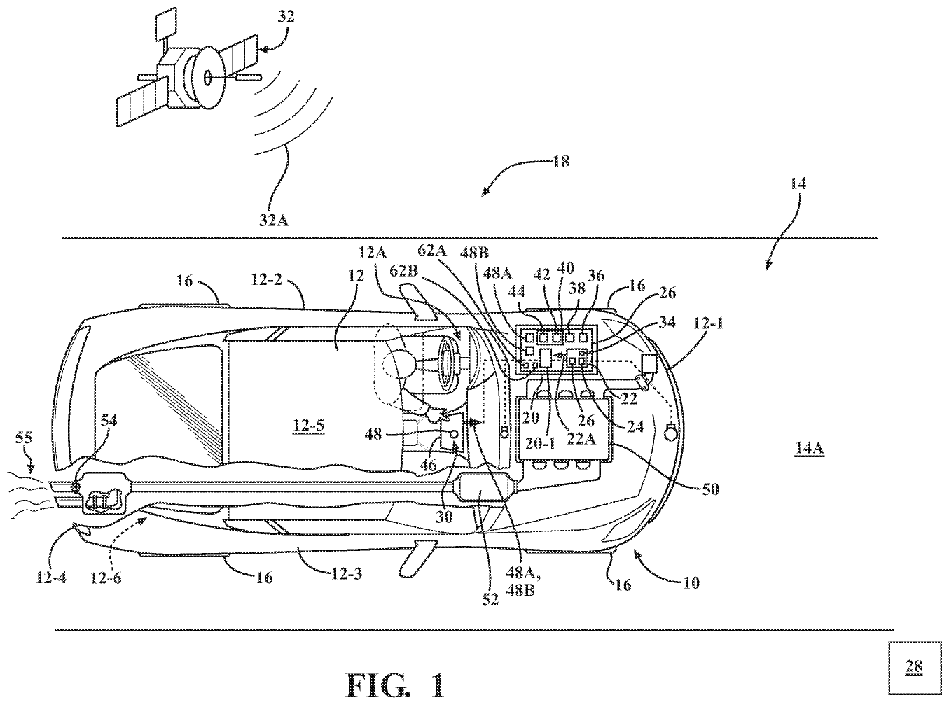

Referring to the drawings, wherein like reference numbers refer to like components, FIG. 1 shows a schematic view of a motor vehicle 10 having a vehicle body 12. The vehicle body 12 may have a leading side or front end 12-1, a left body side 12-2, right body side 12-3, a trailing side or back end 12-4, a top side or section, such as a roof, 12-5, and a bottom side or undercarriage 12-6. The vehicle body 12 generally defines a cabin 12A for an operator and passengers of the vehicle 10. The vehicle 10 may be used to traverse a geographical area 14 with associated roads and physical objects, such as residential complexes, places of business, landmarks, sights, and attractions.

As shown in FIG. 1, the vehicle 10 may include a plurality of road wheels 16. Although four wheels 16 are shown, a vehicle with fewer or greater number of wheels, or having other means, such as tracks (not shown), of traversing a road surface 14A or other portions of the geographical area 14 is also envisioned. The vehicle 10 may use a data gathering and processing system 18 (shown in FIG. 1) to assist the vehicle's operator with vehicle localization and guidance, for example while traversing the geographical area 14. With respect to the present disclosure, the data gathering and processing system 18 is also used for automatic selection of operating modes of various features or systems of the motor vehicle 10, examples of which will be described in detail below.

The data gathering and processing system 18 includes a programmable electronic controller 20 is arranged on the vehicle 10 and may be integral to a central processing unit (CPU). The controller 20 is in communication with various vehicle sensors (not shown) and may be configured to use data captured by such sensors for various purposes, such as to establish a 280-degree view of the terrain 14, to execute perception algorithms, etc. The controller 20 includes a memory that is tangible and non-transitory. The memory may be a recordable medium that participates in providing computer-readable data or process instructions. Such a medium may take many forms, including but not limited to non-volatile media and volatile media. Non-volatile media used by the controller 20 may include, for example, optical or magnetic disks and other persistent memory.

The controller 20 also includes algorithms that may be implemented as electronic circuits, e.g., FPGA, or as algorithms saved to non-volatile memory. Volatile media of the controller 20 memory may include, for example, dynamic random-access memory (DRAM), which may constitute a main memory. Memory of the controller 20 may also include a flexible disk, hard disk, magnetic tape, other magnetic medium, a CD-ROM, DVD, other optical medium, etc. The controller 20 may be equipped with a high-speed primary clock 20-1, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 20 or accessible thereby may be stored in the controller memory and automatically executed to provide the required functionality. Controller 20 may be configured, i.e., structured and programmed, to receive and process captured raw data signals gathered by the vehicle sensors.

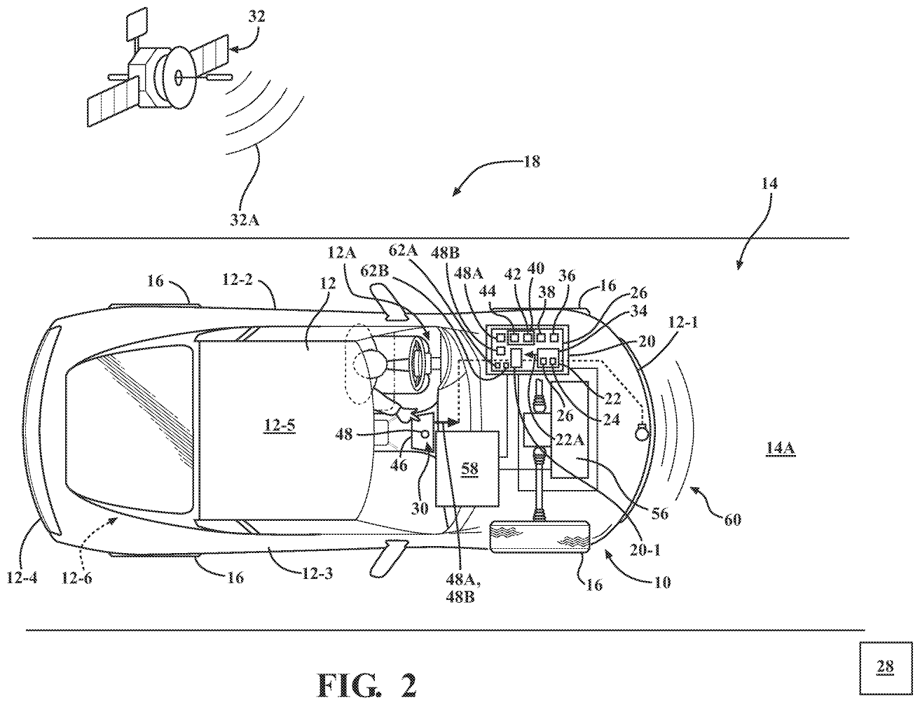

As shown, the electronic controller 20 includes a navigation module or device 22 in communication with the electronic controller 20. The navigation module 22 includes a map 24 of the geographical area with the terrain 14 stored within its memory and is generally configured to establish navigation routes for guidance of the vehicle 10 through the terrain 14. The navigation module 22 may be configured to determine a navigation route 26 to a particular destination 28 through the terrain 14, such as following a request for determination of the subject route by an operator of the vehicle 10. The controller 20 is specifically configured to access the navigation route 26 in the navigation module 22 or receive the navigation route therefrom. The navigation module 22 is generally configured to output the determined navigation route 26 and display the route on a navigation screen 30 (shown in FIGS. 1 and 2) arranged in the vehicle cabin 12A.

As defined herein, the data gathering and processing system 18 also includes a global positioning system (GPS) 32 having earth-orbiting satellites in communication with the navigation module 22. The navigation module 22 may be configured to receive from the GPS 32 a signal(s) 32A indicative of a current position of the GPS satellite(s) relative to the vehicle 10. The navigation module 22 may be additionally configured to use the signal(s) 32A to determine a current geographical location or position 34 of the vehicle 10 relative to the terrain 14 and then communicate to the controller 20 an electronic signal 22A indicative of the determined current geographical position. Alternatively, the electronic signal 22A communicated by the navigation module 22 to the controller 20 may be indicative of the received satellite signal(s) 32A and the controller will use the signal(s) 22A to determine the current geographical position 34 of the vehicle 10.

Generally, each GPS satellite continuously transmits a radio signal indicative of the current time and the satellite's position. Since the speed of radio waves is constant and independent of the GPS satellite speed, the time delay between when the satellite transmits a signal and the receiver receives it is proportional to the distance from the satellite to the receiver. The navigation module 22 typically monitors multiple satellites and solves equations to determine the precise position of the vehicle 10 and its deviation from true time. The navigation module 22 generally requires a minimum of four GPS satellites to be in view for the module to compute three position coordinates and the clock deviation from satellite time.

The controller 20 is configured or programmed to determine a location or address 36 of a selected waypoint 38, such as a residential or a commercial structure, on the navigation route 26 and relative to the current position 34 of the vehicle 10. The controller 20 is additionally programmed with an algorithm 40 for execution by the controller to automatically select an operating mode 42 of a particular vehicle feature. Generally, within the context of the present disclosure, the subject vehicle feature may be an auxiliary or accessory system or device whose operation affects or alters external sound of the vehicle 10. During operation, motor vehicles typically generate various noises. The operating mode 42 of the motor vehicle feature to be selected by the controller 20 may be specifically configured to generate a level of sound or noise below a predetermined level 44, as measured by an appropriate sound level meter externally to the vehicle body 12.

The data gathering and processing system 18 additionally includes an input device 46 arranged in the vehicle cabin 12A and operatively connected to the navigation module 22, for example, using the navigation screen 30. In general, the input device 46 may be configured as an operator-to-vehicle control interface, as exemplified by non-limiting examples such as tactile buttons, turn and push dials, capacitive touch and/or proximity sensors, visual gesture and voice recognition devices, etc. for setting programmable vehicle features. The controller 20 is configured to receive an input signal 48 indicative of available vehicle feature option(s), from the input device 46, such as via manual selection, by the vehicle operator. With respect to specific embodiments of the present disclosure, the input 48 includes at least one of a geographical condition 48A and a temporal, i.e., time-based, condition 48B for operation of the motor vehicle feature.

In an embodiment of the motor vehicle 10 including an internal combustion (IC) engine 50 (shown in FIG. 1), the vehicle feature may be a multiple-mode exhaust system 52 connected to the IC engine. As shown, the multiple-mode exhaust system 52 includes an exhaust-flow control valve 54 configured to regulate restriction of exhaust gas flow 56 from the IC engine 50 by switching between multiple exhaust operating modes. In such an embodiment, the electronic controller 20 may be configured to select the operating mode 42 of the subject motor vehicle feature via regulating the exhaust-flow control valve 54 to switch the multiple-mode exhaust system 52 to a high-restriction mode. The high-restriction mode of the multiple-mode exhaust system 52 results in a relatively quieter sound generated by the IC engine 50 during its operation. Such a high-restriction mode of the multiple-mode exhaust system 50 may be part of a “tour” operating mode of the vehicle 10 designed to enhance vehicle comfort. Conversely, a low-restriction mode of the multiple-mode exhaust system 52 results in a relatively noisier exhaust sound generated by the IC engine 50. Such a low-restriction mode of the multiple-mode exhaust system 52 may be part of a “sport” operating mode of the vehicle 10 designed to enhance vehicle performance.

In another embodiment, the motor vehicle 10 may be powered by non-internal combustion technology. For example, the vehicle 10 may include electric propulsion, such as having electric motor(s) 56 powered by electrochemical batteries 58 (shown in FIG. 2) or a fuel cell. In such a motor vehicle 10 the vehicle feature may be an electronically synthesized or generated external sound 60. Such an external sound 60 may be generated to provide the vehicle 10 with a distinct sound signature and/or project an alert to nearby pedestrians. In the embodiment of vehicle 10 shown in FIG. 2, the electronic controller 20 may be configured to select the operating mode 42 of the subject motor vehicle feature via regulating quality (or type) and volume of the electronically synthesized external sound 60 to a quiet or silent setting.

The controller 20 is configured to set, i.e., store in its non-volatile memory, at least one of the geographical and the temporal condition 48A, 48B for operation of the vehicle feature. The controller 20 is also configured to determine a current geographical location 62A of the vehicle 10 and/or a current time 62B. The controller 20 is additionally configured to compare the current geographical location 62A with the corresponding set geographical condition 48A. For example, the geographical condition 48A may be set as a quiet zone defined by a predetermined (e.g., operator selected) radius R from a particular geographical location, such as a residential address or a hospital. When the current geographical location 62A is determined to be within the set quiet zone, the controller 20 would select the high-restriction operating mode 42 of the multiple-mode exhaust system 52 or the quiet or silent setting of the electronically synthesized external sound 60.

On the other hand, the temporal condition 48B may be set as a quiet period, such as a 9 PM-9 AM time slot. When the current time 62B is determined to be within the set quiet period, the controller 20 would select the high-restriction operating mode 42 of the multiple-mode exhaust system 52 or the quiet or silent setting of the electronically synthesized external sound 60. The controller 20 may use the internal clock 20-1 or rely on the satellite signal(s) 32A, which may include a time of the signal transmission, to determine the current time. The controller 20 may then compare the current time 62B with the saved temporal condition 48B to determine when the mode 42 of the respective vehicle feature is to be activated. Accordingly, the controller 20 is configured to select the operating mode 42 of a particular vehicle feature when the current geographical location and/or the current time 62A, 62B matches the corresponding set condition 48A, 48B. Multiple quiet zones and corresponding quiet time slots may be stored within the non-volatile memory of the electronic controller 20 and selected by the vehicle operator as needed.

The input signal 48 for setting a location and/or temporal situation may be generated from a list of alternatives received through various download/upload options. For example, the geographical and temporal conditions 48A, 48B may be selected by traversing a list of categories in the vehicle which, when selected, would download a list of locations (e.g., hospitals in a particular geographical area) and/or temporal conditions. The geographical and temporal conditions 48A, 48B may also be selected by traversing such a list online (mobile or web) and then pushed to the vehicle 10. The geographical and temporal conditions 48A, 48B may also be conveyed to the vehicle 10 via a transportable memory device and either wirelessly or physically transferred to the memory of the controller 20.

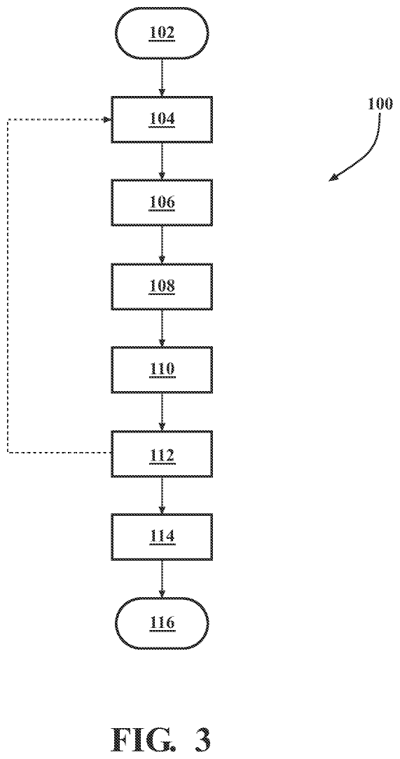

FIG. 3 depicts a method 100 of automatic selection of an operating mode 42 of a motor vehicle feature using the vehicle data gathering and processing system 18, as described above with respect to FIGS. 1-2. The method 100 may be performed via the system 18 utilizing the electronic controller 20 programmed with the algorithm 40. The method 100 initiates in frame 102 with initializing the vehicle data gathering and processing system 18 for communication and data input. Following frame 102, the method proceeds to frame 104. In frame 104, the method includes receiving, via the electronic controller 20, the input signal 48 communicated by an input device 46, including the geographical and/or the temporal conditions 48A, 48B for operation of the vehicle feature. After frame 104, the method advances to frame 106.

In frame 106 the method includes setting, via the electronic controller 20, the geographical and/or the temporal conditions 48A, 48B for operation of the vehicle feature. Following frame 106, the method proceeds to frame 108. In frame 108, the method includes determining, via the electronic controller 20, the current geographical location of the motor vehicle and/or the current time 62A, 62B. Following frame 108, the method proceeds to frame 110. In frame 110, the method includes comparing, via the electronic controller 20, the current geographical location and/or the current time 62A, 62B with the corresponding set condition 48A, 48B. Following frame 110, the method moves on to frame 112. In frame 112, the method includes selecting, via the electronic controller 20, the operating mode 42 of the motor vehicle feature when the current geographical location and/or the current time 62A, 62B matches the corresponding set condition 48A, 48B.

As described above with respect to FIGS. 1-2, a specific operating mode 42 may be selected by switching the multiple-mode exhaust system 52 to a high-restriction mode via the exhaust-flow control valve 54 to thereby ensure a relatively quiet ICE 50 sound. The controller 20 may preset the high-restriction mode 42 of the multiple-mode exhaust system 50 prior to the start of the ICE 50 when the ICE is to be started within the geographical location 62A, thereby matching the set condition 48A, and/or the current time 62B matches the corresponding set temporal condition 48B. Alternatively, the controller 20 may switch from the low-restriction mode to the high-restriction mode of the exhaust system 50 as the vehicle 10 enters the geographical location 62A, thereby matching the set condition 48A, and/or the current time 62B reaches the corresponding set condition 48B. In the embodiment the motor vehicle 10 with electric propulsion, the controller 20 may analogously activate the quiet mode 42 of the electronically synthesized external sound 60 vehicle feature.

Following such automatic selection of the operating mode 42 of the motor vehicle 10 feature via the controller 20, the method may return to frame 104 for re-setting the conditions 48A, 48B or to frame 108 for continued determination of the current geographical position 62A of the vehicle 10 and/or the current time 62B while traversing the geographical area 14. Alternatively, the method may move on to frame 114 for deactivation of the operating mode 42 of the motor vehicle 10 feature upon determination of the new geographical position 62A of the vehicle 10 and/or the current time 62B no longer matching the presently set conditions 48A, 48B. Following either frame 112 or frame 114, the method may conclude in frame 116.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of automatic selection of an operating mode of a motor vehicle feature, the method comprising:
receiving, via an electronic controller, an input signal communicated by an input device, including at least one of a geographical and a temporal condition for operation of the motor vehicle feature;
setting, via the electronic controller, at least one of the geographical and the temporal condition for operation of the motor vehicle feature;
determining, via the electronic controller, a current geographical location of the motor vehicle and/or a current time;
comparing, via the electronic controller, the current geographical location and/or the current time with the corresponding set condition; and
selecting, via the electronic controller, the operating mode of the motor vehicle feature when the current geographical location and/or the current time matches the corresponding set condition.

2. The method according to claim 1, wherein the operating mode of the motor vehicle feature generates an external sound below a predetermined sound level.

3. The method according to claim 2, wherein the motor vehicle includes an internal combustion engine, and wherein the motor vehicle feature is a multiple-mode exhaust system connected to the internal combustion engine.

4. The method according to claim 3, wherein the multiple-mode exhaust system includes an exhaust-flow control valve, and wherein selecting the operating mode of the motor vehicle feature includes regulating the exhaust-flow control valve to switch the multiple-mode exhaust system to a high-restriction mode.

5. The method according to claim 2, wherein the motor vehicle includes electric propulsion, and wherein the motor vehicle feature is an electronically synthesized external sound.

6. The method according to claim 5, wherein selecting the operating mode of the motor vehicle feature includes selecting at least one of quality and volume of the electronically synthesized external sound.

7. The method according to claim 1, wherein the motor vehicle includes a navigation device in communication with each of the electronic controller and a global positioning system (GPS), and wherein determining the current geographical location of the motor vehicle includes receiving, via the navigation device, a satellite signal from the GPS.

8. The method according to claim 7, wherein determining the current geographical location of the motor vehicle additionally includes communicating to the electronic controller, via the navigation device, an electronic signal indicative of the received satellite signal.

9. The method according to claim 1, wherein the electronic controller includes an internal clock, and wherein determining the current time is achieved via the internal clock.

10. The method according to claim 1, wherein the temporal condition is a 9 PM-9 AM quiet time slot and the geographical condition is a quiet zone defined by a predetermined radius from a particular geographical location.

11. A system for automatic selection of an operating mode of a motor vehicle feature, the system comprising:
an input device arranged in a motor vehicle; and
an electronic controller programmed with an algorithm and configured to execute the algorithm to:
receive an input signal, communicated by the input device, including at least one of a geographical and a temporal condition for operation of the motor vehicle feature;
set at least one of the geographical and the temporal condition for operation of the motor vehicle feature;
determine a current geographical location of the motor vehicle and/or a current time;
compare the current geographical location and/or the current time with the corresponding set condition; and
select the operating mode of the motor vehicle feature when the current geographical location and/or the current time matches the corresponding set condition.

12. The system according to claim 11, wherein the operating mode of the motor vehicle feature generates an external sound below a predetermined sound level.

13. The system according to claim 12, wherein the motor vehicle includes an internal combustion engine, and wherein the motor vehicle feature is a multiple-mode exhaust system connected to the internal combustion engine.

14. The system according to claim 13, wherein the multiple-mode exhaust system includes an exhaust-flow control valve, and wherein the electronic controller is configured to select the operating mode of the motor vehicle feature via regulating the exhaust-flow control valve to switch the multiple-mode exhaust system to a high-restriction mode.

15. The system according to claim 12, wherein the motor vehicle includes electric propulsion, and wherein the motor vehicle feature is an electronically synthesized external sound.

16. The system according to claim 15, wherein the electronic controller is configured to select the operating mode of the motor vehicle feature via selecting at least one of quality and volume of the electronically synthesized external sound.

17. The system according to claim 11, wherein the motor vehicle includes a navigation device in communication with each of the electronic controller and a global positioning system (GPS), and wherein the navigation device is configured to receive a satellite signal from the GPS and thereby facilitate the electronic controller to determine the current geographical location of the motor vehicle.

18. The system according to claim 17, wherein the navigation device is additionally configured to communicate to the electronic controller an electronic signal indicative of the received satellite signal.

19. The system according to claim 11, wherein the electronic controller includes an internal clock configured to determine the current time.

20. A method of automatic selection of an operating mode of a motor vehicle feature, the method comprising:
receiving, via an electronic controller, an input signal communicated by an input device, including at least one of a geographical and a temporal condition for operation of the motor vehicle feature;
setting, via the electronic controller, at least one of the geographical and the temporal condition for operation of the motor vehicle feature;
determining, via the electronic controller, a current geographical location of the motor vehicle and/or a current time, wherein:
determining the current geographical location of the motor vehicle includes receiving, via a navigation device in communication with each of the electronic controller and a global positioning system (GPS), a satellite signal from the GPS;
determining the current time is achieved via an internal clock of the electronic controller;
comparing, via the electronic controller, the current geographical location and/or the current time with the corresponding set condition; and
selecting, via the electronic controller, the operating mode of the motor vehicle feature when the current geographical location and/or the current time matches the corresponding set condition to generate an external sound below a predetermined sound level.
